(19) United States
(12) Patent Application Publication
(10) Pub. No.: US 2017/0155167 A1
(43) Pub. Date: Jun. 1, 2017

(54) LITHIUM ION SECONDARY BATTERY AND A METHOD FOR PRODUCING THE SAME

(71) Applicant: HITACHI MAXELL, LTD., Osaka (JP)

(72) Inventors: Hiroshi Abe, Ibaraki-shi (JP); Seiji Ishizawa, Ibaraki-shi (JP); Toshihiro Abe, Ibaraki-shi (JP)

(73) Assignee: HITACHI MAXELL, LTD., Osaka (JP)

(21) Appl. No.: 15/357,390

(22) Filed: Nov. 21, 2016

(30) Foreign Application Priority Data
Nov. 26, 2015 (JP) 2015-230234
Nov. 8, 2016 (JP) 2016-217887

(51) Int. Cl. H01M 10/0525; H01M 4/13; H01M 4/38; H01M 4/485; H01M 10/0585; H01M 2/16

(52) U.S. Cl. CPC H01M 10/0525; H01M 10/0585; H01M 2/1686; H01M 4/386; H01M 4/485; H01M 4/13; H01M 2220/30

(57) ABSTRACT

The stacked electrode body of the lithium ion secondary battery has an end surface parallel to the stacked direction of the positive electrode, the negative electrode and the separator. The end surface is opposed to the third electrode to dope Li ions into the negative electrode. (1) When the lithium ion secondary battery is discharged at a discharge current rate of 0.1 C to reach a voltage reaches 2.0V, a molar ratio (Li/M) of the Li and the metal M other than Li included in the positive electrode active material is 0.8 to 1.05, or (2) the third electrode includes a Li supply source arranged such that the Li supply source is opposed to the end surface of the stacked electrode body, and the negative electrode can be doped with Li ions supplied from the Li supply source when an electrical connection to the third electrode is provided.

### TECHNICAL FIELD

The present invention relates to a lithium ion secondary battery with a high capacity and having excellent charge discharge cycle characteristics. The present invention also relates to a production method thereof.

### TECHNICAL BACKGROUND

A lithium ion secondary battery is a kind of electrochemical elements, and is considered to be used in portable devices, automobiles, electric tools, electric chairs, and electricity storage systems both for family use and business use, since it has a high energy density. Particularly, in the field of portable devices, it is widely used as a power source of cell phones, smartphones or tablet type PCs.

As apparatus using lithium ion secondary batteries have been spread, it has been demanded to improve its high capacity and other various aspects of its battery properties. Particularly, it has been strongly demanded to improve the charge discharge cycle characteristic since it is a secondary battery.

Usually, as a negative electrode active material of the lithium ion secondary battery, a carbon material such as graphite is widely used and is capable of insertion and desorption of lithium (Li) ions. On the other hand. Si or Sn or a material including such an element have been examined as a material capable of insertion and desorption of more amounts of lithium (Li) ions, and in this respect, an SiOₓ material having a structure that fine particles of Si are dispersed in SiO₂ is particularly focused on. Also, since these materials have a low conductivity, it has been proposed to make a structure that the surface of the particles is coated with a conductive material such as carbon (Patent References No. 1 and No. 2).

In addition, a negative electrode material including an Si has relatively high irreversible capacity, and therefore, it is desirable to introduce Li ions into the negative electrode side in advance, for example, by using a Li metal as a Li source. According to a conventional method, Li is arranged to be opposed to the positive and negative composition layers, thereby introducing Li ions into the negative electrode (See Patent References No. 3 to 6).

Also, there is another conventional method to carry out a pre-doping alkali metal ions into an electrode as explained below. That is, a positive electrode, a negative electrode and a supplemental electrode having an alkali metal ion source are arranged in such a way that they are immersed in a liquid for pre-doping eluting alkali metal ions. A DC power source is connected between the battery electrode and the supplemental electrode. In this method, the direct current thereby generates an electric field in the same direction as that of the electrode surface of the battery electrode (See Patent Reference No. 7).

### PRIOR ART REFERENCES

### Patent References

Patent Reference No. 1: Japanese Laid-Open Patent Publication No. 2004-47404

Patent Reference No. 2: Japanese Laid-Open Patent Publication No. 2005-259697

Reference No. 3: International Patent Publication No. WO98/033227

Reference No. 4: International Patent Publication No. WO2007/072713

Patent Reference No. 5: Japanese Laid-Open Patent Publication No. 2007-299698

Patent Reference No. 6: Japanese Laid-Open Patent Publication No. 2015-060881

Patent Reference No. 7: Japanese Laid-Open Patent Publication No. 2015-088437

### SUMMARY OF THE INVENTION

### The Objectives to Solve by the Invention

However, when the material S, i.e., a negative electrode material including Si as a negative electrode active material, is used to introduce Li ions by opposing to the positive and negative composition layer surfaces as disclosed in Patent References Nos. 3, 4 and 6, the material S would take Li ions and extremely expand. Therefore, the negative electrode composition layer might fall off from the negative electrode current collector.

Also, in accordance with Patent Reference No. 7, when a pre-doping is carried out by immersing the battery electrodes in a liquid for pre-doping followed by assembling them into a battery, it would have to say that it is not a good handling property but it is complicated. Furthermore, if an entire body of the electrode is immersed into a liquid for pre-doping, Li might be deposited on the tab part.

The present invention was accomplished in view of the circumstances as noted above, and provides a lithium ion secondary battery having a high-capacity and superior in the charge discharge cycle characteristics, and a production method thereof.

### Means to Solve the Objectives

There is provided a lithium ion secondary battery as follows. The lithium ion secondary battery comprises: a stacked electrode body comprising a positive electrode, a negative electrode, and a separator interposing between the positive electrode and the negative electrode; and a third electrode used to dope Li ions into the negative electrode. The stacked electrode body has a plain surface and an end surface parallel to a stacked direction of the positive electrode, the negative electrode and the separator. The negative electrode comprises a negative electrode composition layer comprising a negative electrode active material at least on one surface of a negative electrode current collector. The negative electrode active material includes a material S including Si. Assuming that 100 mass % is a total of the negative electrode active material included in the negative electrode composition layer, a content of the material S is higher than 5 mass %. The positive electrode comprising a positive electrode composition layer comprising a metal oxide of Li and a metal M other than Li as a positive electrode active material, the positive electrode composition layer being arranged on at least one surface of a positive electrode current collector. The third electrode is arranged in such a manner that at least a part of the third electrode is opposed to the end surface of the stacked electrode body. The lithium ion secondary battery is discharged at a discharge current rate of 0.1 C to reach a voltage reaches 2.0V, a molar ratio (Li/M) of the Li and the metal M other than Li included in the positive electrode active material is 0.8 to 1.05.

There is also provided another lithium ion secondary battery as follows. The lithium ion secondary battery comprises: a stacked electrode body comprising a positive electrode, a negative electrode, and a separator interposing between the positive electrode and the negative electrode; and a third electrode used to dope Li ions into the negative electrode. The stacked electrode body has a plain surface and an end surface parallel to a stacked direction of the positive electrode, the negative electrode and the separator. The negative electrode comprises a negative electrode composition layer comprising a negative electrode active material at least on one surface of a negative electrode current collector. The negative electrode active material includes a material S including Si. Assuming that 100 mass % is a total of the negative electrode active material included in the negative electrode composition layer, a content of the material S is higher than 5 mass %. The positive electrode comprising a positive electrode composition layer comprising a metal oxide of Li and a metal M other than Li as a positive electrode active material, the positive electrode composition layer being arranged on at least one surface of a positive electrode current collector. The third electrode comprises a Li supply source in a manner that the third electrode is arranged such that the Li supply source is opposed to the end surface of the stacked electrode body. The negative electrode is doped with Li ions supplied from the Li supply source by making an electrical connection to the third electrode.

There is provided a method for producing a lithium ion secondary battery. The method produces a lithium ion secondary battery comprising: a stacked electrode body comprising a positive electrode, a negative electrode, and a separator interposing between the positive electrode and the negative electrode, the negative electrode comprising a negative electrode composition layer comprising a negative electrode active material at least on one surface of a negative electrode current collector, the negative electrode active material including a material S including Si; and a third electrode used to dope Li ions into the negative electrode. The stacked electrode body has a plain surface and an end surface parallel to a stacked direction of the positive electrode, the negative electrode and the separator. The method comprising: providing the third electrode comprising a Li supply source in a manner that the third electrode is arranged such that the Li supply source is opposed to the end surface of the stacked electrode body; and making an electrical connection to the third electrode such that the negative electrode is doped with Li ions supplied from the Li supply source.

### Effects of the Invention

According to the present invention, it can be possible to provide a lithium ion secondary battery having a high capacity and being excellent in charge discharge cycle characteristics.

### BRIEF DESCRIPTION OF THE DRAWINGS

FIG. 1 is a plan view schematically showing an example of the positive electrode of the lithium ion secondary battery of the present invention.

FIG. 2 is a plan view schematically showing an example of the negative electrode of the lithium ion secondary battery of the present invention.

FIG. 3 is a perspective view schematically showing an example of the stacked electrode body of the lithium ion secondary battery of the present invention.

FIG. 4 is a perspective view schematically showing an example of a third electrode of the lithium ion secondary battery of the present invention.

FIG. 5 is a perspective view showing a condition when the stacked electrode body of FIG. 3 is combined with the third electrode of FIG. 4.

FIG. 6 is a perspective view schematically showing an example of the electrode body of the lithium ion secondary battery of the present invention.

FIG. 7 is a plan view schematically showing an example of the lithium ion secondary battery of the present invention.

FIG. 8 is a cross section view at the line I-I of FIG. 7.

FIG. 9 is a plan view schematically showing a third electrode used in Comparative Example 1.

### EMBODIMENTS TO CARRY OUT THE INVENTION

The negative electrode of the lithium ion secondary battery of the present invention employs a structure in which, for example, a negative electrode composition layer including a negative electrode active material, a binder and etc. is formed on one surface or both surfaces of a current collector.

In the present invention, the negative electrode active material includes a material S including Si. It is known that Si can introduce Li ion when it is alloyed with Li. It is, however, known that it shows a large volume expansion at the time when Li is introduced.

It is characterized in that the materials S has a capacity of 1000 mAh/g or more, and it is a level that remarkably exceeds a theoretical value of the capacity of graphite, that is, 372 mAh/g. Meanwhile, when compared with the conventional graphites in view of charge discharge efficiency (more than 90%), there were many instances where the initial charge discharge efficiency did not reach 80% if using the material S. Therefore, an irreversible capacity could be increased. Therefore, it would have to say that there were an issue in the charge discharge cycle characteristics. Thus, it is considered to introduce Li ions into the negative electrode in advance.

As a method to introduce Li ions into the negative electrode active material, there was a way to laminate a lithium metal foil on the negative electrode composition layer or to form a Li vapor deposition layer on the negative electrode composition layer. In this way, after a negative electrode composition layer was formed in advance, a Li source was arranged to be opposed to the composition layer, followed by making an electrochemical contact (short circuit), thereby introducing Li ions therein. However, in this case, when Li ions are introduced in a configuration that is opposed to the composition layer, it must have arranged each Li source for each negative electrode composition layer inside the stacked electrode body, and thereby decreasing production efficiency. In order to modify it, there has been used a metal foil having a through hole from one surface to the other surface, the metal foil becoming a support of the composition layers of the positive electrode and the negative electrode (i.e., a current collector). In this way, it is possible to arrange a Li source only on the outermost surface of the stacked electrode body in the stacking direction, while Li ions can entirely spread into the stacked electrode body through the through hole of the metal foil, thereby allowing Li ions to be introduced into the all negative electrodes.

However, since the material S can accept a large amount of Li ions, in turn it shows a significant expansion upon accepting Li ions. Therefore, the negative electrode composition layer of the negative electrode closest to the Li source receives the most amounts of Li ions, thereby remarkably expanding. As a result, the negative electrode composition layer might fall off by losing an adhesion state with the negative electrode current collector.

In view of the above, the present invention uses a stacked electrode body which has been formed by stacking a positive electrode and a negative electrode with interposing a separator therebetween. At the end surface (i.e., a surface that is parallel to the stacking direction of the positive electrode, the negative electrode and the separator, and that is made by each end surface of these elements as stacked), there is arranged a Li supply source for doping Li ions to the negative electrode. As a result, it is possible to reduce the position to place the Li supply source inside a battery as little as possible, thereby removing the complicatedness to arrange it. In addition, it is possible to restrict a situation where any part of the negative electrode composition layer of the negative electrode is excessively expanded to lose an adhesion with the current collector. Furthermore, with respect to the current collector of the positive electrode and the negative electrode in the present invention, there becomes needless to provide a through hole thereon. Therefore, it can be possible to adopt a current collector of the negative electrode to sufficiently endure the stress when it is subject to the expansion and shrinkage of the negative electrode active material as well as to the expansion and shrinkage of the negative electrode composition layer upon charging and discharging of the battery.

It is noted that whether to dope Li ions in the negative electrode can be detected from a molar ratio (Li/M) of the Li and the metal M other than Li included in the positive electrode active material when a battery is discharged at a discharge current rate of 0.1 C until its voltage reaches 2.0V. In one embodiment of the lithium ion secondary battery of the present invention, the molar ratio Li/M is 0.8 or more and 1.05 or less. When the material S is employed as a negative electrode active material but when the negative electrode is not doped with Li ions, such a battery has a molar ratio Li/M smaller than the lower limit above.

The composition analysis of the positive electrode active material at the time when it is discharged to reach a voltage of 2.0V at a discharge current rate of 0.1 C can be carried out by means of ICP (Inductive Coupled Plasma) method as follow. First, 0.2 g of a positive electrode active material as a measurement target is collected and put into a 100 mL container. Then, 5 mL of pure water, 2 mL of aqua regia, and 0.1 mL of pure water are sequentially added in this order to cause heat solution, followed by cooling and diluting 25 times with pure water. An ICP analyzer, “ICP-757” manufactured by JARRELASH Co., Ltd. is used to carry out a composition analysis by a calibration curve method. The quantities of the composition can be identified from the results obtained. It is noted that the Molar ratio Li/M in the Examples as discussed later was measured by the method above.

The material S is a negative electrode materials including Si. The examples of the material S can include a composite material in which Si powders are composed with carbon, or a material further coating it with a carbon material; a material in which Si powders are held by graphenes or scale-like graphites; and a material represented by a composition formula SiOₓ including Si and O as constituent elements (here, the atom ratio x of O to Si is 0.5≦x≦1.5). Particularly, it is preferable to use SiOₓ.

The SiOₓ explained above can include microcrystal or amorphous phase of Si. In this case, the atomic ratio of Si and O should be determined with including the microcrystal or the amorphous phase of Si. That is, the SiOₓ can include one having a structure in which Si (e.g., microcrystalline Si) is dispersed in an amorphous SiO₂ matrix, and in this case, it can satisfy 0.5≦x≦1.5 where the atomic ratio x can be determined by including the amorphous SiO₂ and the Si dispersed in the amorphous SiO₂. For example, when a material has a structure in which Si is dispersed in an amorphous SiO₂ matrix, and it has a molar ratio of SiO₂ and Si of 1:1, this material can be expressed by a structural formula of SiO because of x=1. In the case of the material having such a structure, a peak resulting from the presence of Si (microcrystalline Si) might not be observed. e.g., by means of X-ray diffraction analysis, but the presence of fine Si can be confirmed by means of transmission electron microscope observation.

In addition, it is favorable that the SiOₓ as explained above is a composite of a carbon material. For example, it is desirable that the surface of the SiOₓ is coated with a carbon material. Usually, SiOₓ has a poor conductivity. Therefore, when it is used as a negative electrode active material, it would be necessary that from the view point of securing good battery properties, a conductive material (i.e., conductive assistant) is used such that the mixing and the dispersing of the SiOₓ and the conductive material in the negative electrode are made better, thereby forming a superior conductive network. By using a composite of SiOₓ and carbon material, a better conductive network can be formed in the negative electrode rather than using a material obtained by merely mixing SiOₓ with carbon material.

That is, the specific resistance value of an SiOₓ is generally 10³ to 10⁷ kΩcm, whereas the specific resistance value of the carbon material as exemplified above is generally 10⁻⁵ to 10 kΩcm. The conductivity of the SiOₓ can be therefore improved by complexing the SiOₓ with the carbon material.

The examples of the composite of the SiOₓ with the carbon material can include a granular material including SiOₓ and carbon material, in addition to the above composite obtained by coating the surface of the SiOₓ with the carbon material.

Preferred examples of the carbon material that can be used with the SiOₓ to form a composite can include a low crystalline carbon, carbon nanotube, and a vapor grown carbon fiber.

Specifically, it is preferable that the carbon material is at least one selected from the group consisting of a fibrous or coil-shaped carbon material, carbon black (which may include acetylene black and ketjen black), artificial graphite, an easily-graphitizable carbon, and a hardly-graphitizable carbon. The fibrous or coil-shaped carbon material can be preferably adopted because it has a large surface area and is easy to form a conductive network. It is preferable to use the carbon black (which may include acetylene black and ketjen black), the easily-graphitizable carbon, and the hardly-graphitizable carbon because these have a high electrical conductivity and a high liquid-retaining property, and also are likely to remain in contact with the SiOₓ particles even in a condition where the SiOₓ particles expand and contract.

Among the above carbon materials, it is particularly preferable to use the fibrous carbon material when employing a composite of the SiOₓ and the carbon material as a granular material. This is because the fibrous carbon material is in the form of a fine thread and having a high flexibility, and it can thus follow the expansion and contraction of the SiOₓ during charge and discharge of the battery. Moreover, the fibrous carbon material has a high bulk density, and thus can create many contact points to the SiOₓ particles. The examples of the fibrous carbon can include a polyacrylonitrile (PAN) carbon fiber, a pitch carbon fiber, a vapor grown carbon fiber, and carbon nanotube. One of any as exemplified above can be used.

When the composite of the SiOₓ and the carbon material is used as the negative electrode, the ratio of the SiOₓ and the carbon material is determined so that the carbon material is preferably 5 parts by mass or more, and more preferably 10 parts by mass or more, with respect to 100 parts by mass of the SiOₓ, thereby producing a good effect of the combination of the SiOₓ and the carbon material. In the composite as noted above, if the ratio of the carbon material to be combined with the SiOₓ is too large, the amount of the SiOₓ in the negative electrode mixture layer is reduced, which in turn might reduce the effect of increasing the capacity. Therefore, the carbon material is preferably 50 parts by mass or less, and more preferably 40 parts by mass or less, with respect to 100 mass by weight of the SiOₓ.

The composite of SiOₓ and carbon material can be obtained. e.g., in the following manner.

When the composite is formed by coating the surface of the SiOₓ with the carbon material, e.g., the SiOₓ particles and a hydrocarbon gas are heated in a gas phase, and therefore, the carbon produced by thermal decomposition of the hydrocarbon gas can be deposited on the surfaces of the particles. Such a chemical vapor deposition (CVD) method allows the hydrocarbon gas to be spread over the SiOₓ particles, so that a thin uniform film (carbon material coating layer) including the carbon material with conductivity can be formed on the surfaces of the particles. Thus, it is possible to make the SiOₓ particles uniformly conductive with a small amount of the carbon material.

In the production of the SiOₓ coated with the carbon material, the treatment temperature (ambient temperature) of the CVD method might vary depending on the type of the hydrocarbon gas, but it can be generally 600 to 1200° C. In particular, the treatment temperature is preferably 700° C. or higher, and more preferably 800° C. or higher. This is because the residual impurities can be reduced at setting it at a treatment as high as possible, and therefore, a coating layer including a highly conductive carbon can be formed.

As a liquid source of the hydrocarbon gas, toluene, benzene, xylene, mesitylene, or the like can be used. For easy handling, toluene is particularly preferred. A hydrocarbon gas can be obtained by evaporating the liquid source (e.g., by bubbling with a nitrogen gas). Moreover, a methane gas or acetylene gas can be used.

When a granular material of the SiOₓ and the carbon material is produced, a dispersion in which the SiOₓ is dispersed in a dispersion medium is prepared, which is then sprayed for drying, thereby producing a granular material including a plurality of particles. For example, the dispersion medium can be ethanol. It is appropriate that the dispersion liquid is generally sprayed in an atmosphere at 50 to 300° C. Other than the method explained above, the granular material of the SiOₓ and the carbon material can be also produced by a mechanical granulation method using a vibrating or planetary ball mill, a rod mill, or the like.

Assuming that a total of the negative electrode active material included in the negative electrode composition layer becomes 100 mass %, the content of the material S (e.g., a composite of SiOₓ and carbon material) is 5 mass % or more, and more preferably it is 10 mass % or more, and yet more preferably it is 50 mass % or more. The material S is a material that can achieve a remarkably high capacity compared with graphite as explained before, and therefore, its inclusion in the negative electrode active material even at a small quantity can bring about a capacity improvement effect of a battery. On the other hand, in order to make significant improvement in high capacity of the battery, it is preferable that 10 mass % or more of the material S is included in the total of the negative electrode active material. Depending on the applications of the battery as well as its properties as demanded, the content of the material S can be adjusted. In addition, in order to bring about the introduction effect of Li by means of graphite A and graphite B as described later (this effect is based on the electrochemical contact between Li and the negative electrode), it is preferable that the ratio of the material S is 99 mass % or less, and more preferably it is 90 mass % or less, and yet preferably it is 80 mass % or less.

When the average particle diameter of the material S is too small, the dispersibility of the material S might decrease so that sufficient effects of the present invention could not be obtained. Also, the material S has a large volumetric change by the charge and the discharge of the battery, and therefore, when an average particle diameter is too large, the material S might tend to be collapsed due to the expansion and the shrinkage (this phenomenon leads to a capacity deterioration of the material S). Therefore, it is preferably 0.1 μm or more and 10 μm or less.

In addition to the material S as explained above, the negative electrode can also include a carbon material such as graphite that is able to electrochemically store and release Li. Particularly, it is preferable to use graphite A having an average particle diameter more than 15 μm and 25 μm or less, and graphite B having an average particle diameter of 8 μm or more and 15 μm or less in which the surface of the graphite particles is coated with an amorphous carbon.

The examples of the graphite A above can include natural graphite and artificial graphite that can be used as a negative electrode active material of general lithium ion secondary batteries. The examples of the artificial graphite can include a material that can be obtained by burning coke or an organic matter at 2,800° C. or more; a material that can be obtained by mixing natural graphite with coke or an organic matter followed by carrying out a heat treatment at 2,800° C. or more; and a material in which coke or an organic matter is burned at 2,800° C., which is then coated on the surface of the nature graphite. The graphite used has an R value of 0.05 to 0.2, in which the R value is a peak strength ratio of the peak strength at 1340 to 1370 cm⁻¹ with respect to the peak strength at 1570 to 1590 cm⁻¹ by means of an argon ion laser Raman spectrum. In addition, two or more kinds of graphites can be used as graphite A so long as satisfying the average particle diameter within the range as defined above.

The graphite B is comprised of graphite particles as base particles whose surfaces are coated with an amorphous carbon. In details, it is a graphite having an R value of 0.1 to 0.7 in which the R value is a peak strength ratio of the peak strength at 1340 to 1370 cm⁻¹ with respect to the peak strength at 1570 to 1590 cm⁻¹ by means of an argon ion laser Raman spectrum. It is preferable that the R value is 0.3 or more in order to secure sufficient quantity of the coating by the amorphous carbon. On the other hand, it is also preferable that the R value is 0.6 or less since an excess amount of the coating quantity of the amorphous carbon might increase an irreversible capacity. The graphite B above can be obtained by as follows. For example, a base material of graphite (i.e., base particle) is provided which has a spherical shape made of natural graphite or artificial graphite having d₀₀₂ or 0.338 nm or less, whose surface is coated with an organic compound, followed by burning at 800 to 1500° C. Then, the matter is ground and then passed through a sieve to adjust the size of the granule. The examples of the organic compound coating the mother material can include aromatic hydrocarbon; kinds of tar or pitch obtained by carrying out a condensation polymerization of an aromatic hydrocarbon under heat and pressure; kinds of tar, pitch or asphalt mainly composed of a mixture of aromatic hydrocarbons; and etc. As a method to coat the base material with an organic compound, there can adopt a method in which the base material is impregnated into and mixed with the organic compound. Alternatively, the graphite B can be obtained by means of a vapor phase method through thermolysis of a hydrocarbon gas such as propane or acetylene carbon, thereby making it into carbon to be deposited onto the surface of graphite having d₀₀₂ of 0.338 nm or less.

Furthermore, the graphite B as described above is high in a Li ion receptivity (that can be shown, e.g., as a number representing a ratio of the constant current charge capacity with respect to the total charge capacity). Thus, a lithium ion secondary battery made by using the graphite B together will have a good Li ion receptivity, thereby resulting in further improvement of the charge discharge cycle characteristic. As mentioned above, in case where Li is introduced into the negative electrode including the material S by means of electrochemical contact (i.e., short circuit), it was considered that if the graphite B is used together, the disproportionation during the Li introduction could be controlled to contribute to an improvement of the battery properties.

However, it was found that a single use of graphite B did not sufficiently improve the batteries properties. This is considered because of the mother material as an activated graphite, i.e., graphite B, having a spherical shape, there could exist an area where a single use of the graphite B could not sufficiently secure the points of contact between the particles, and therefore, it could result in irregularity when introducing Li. As a result, it is considered that the Li ion receptivity of the negative electrode as a whole could not be improved, and therefore, the battery properties were not improved significantly. In view of the above, the inventors of the present application have found it essential to employ both graphite B and graphite A, the graphite A having an average particle diameter larger than that of the graphite B. In details, the graphite A has an average particle diameter of more than 15 μm and 25 μm or less. As a result, it was found that the battery properties were remarkably improved. In details, the total content of the graphite A and the graphite B is 20 mass % or more and 99 mass % or less in the total negative electrode active material included in the negative electrode. In addition, the ratio of the graphite A with respect to the graphite B (A/B) should be 0.5 or more and 4.5 or less in the total negative electrode active material included in the negative electrode. Therefore, by using both the graphite A and graphite B, it is possible to reduce the areas where contact of the graphite B is not sufficiently established. In other words, it is considered that by reducing the irregularities of Li ions into the negative electrode, the Li ion receptivity can be increased compared with a single use of the graphite B.

In addition, when the particle size of the graphite A is too small, the specific surface area could be excessively increased (which could result in increase of the irreversible capacity). Thus, it is preferable that the particle size should not be so small. It is, therefore, preferable that an average particle diameter of the graphite A to be used is more than 15 μm. On the other hand, if the particle size of the graphite B is too small, the coating quantity of the amorphous carbon coating the surface can vary, and the effects by the graphite B could not be sufficiently obtained. Thus, it is preferable that the particle size of the graphite B should not be too small. It is, therefore, preferable that the average particle diameter of the graphite B is 8 μm or more.

It is noted that in the specification of the present application, the term “the average particle diameter” regarding the graphites (i.e., graphite A, graphite B and other graphites) and the material S means as follow. A laser dispersion particle size distribution meter (e.g., a micro track particle size distribution measuring equipment, “HRA9320,” made by Nikkiso Co., Ltd.) is used. These particles are dispersed in a media which does not dissolve or swell the particles to measure a particle size distribution. Then, an integral calculus volume is calculated from the smaller particles thereof. In this case, the term corresponds to the value (d_{50%}) median diameter of the 50% diameter of the multiplication fraction of the volume standard.

A specific surface area of the graphite A and the graphite B can be measured as follows. (It is in accordance with a BET method. The example of the equipment used is BELSORP-MINI, a product manufactured by Japan Bell Corporation.) It is preferable that it is 1.0 m²/g or more and 5.0 m²/g or less.

Also, regarding the crystal size Lc in the c-axis direction of the crystal structure of the graphite A and the graphite B, it is preferable that Lc is 3 nm or more, and it is more preferable that it is 8 nm or more, and it is yet more preferable that it is 25 nm or more. Within the ranges noted above, it becomes easier to store or release lithium ions. The upper limit of Lc of the graphite is not limited to a specific value, but it is usually about 200 nm.

Also, in addition to the material S and the graphite A and the graphite B as explained above, the negative electrode active material can include additional negative electrode active material (for example, it can be another graphite in the same type as the graphite A and graphite B, but it has an average particle diameter of less than 15 μm or an average particle diameter of more than 25 μm, and therefore, it does not correspond to the graphite A or the graphite B); a single element of Si or Sn; an alloy including Si or Sn; and an oxide including Si or the Sn. This can be included at a content so long as it does not obstruct the effects in accordance with the present invention.

The binder of the negative electrode composition layer can be selected in such a way that, for example, it is electrochemically inert to Li within the electrical potential range of the negative electrode and that it does not influence on the other components as little as possible. In details, the suitable examples thereof can include styrene-butadiene rubber (SBR), polyvinylidene fluoride (PVDF), carboxymethylcellulose (CMC), polyvinyl alcohol (PVA), methylcellulose, polyimide, polyamideimide, polyacrylic acid, and the derivatives or copolymers thereof. The binder used can be of one kind, or two or more kinds in combination.

The negative electrode composition layer above can further include a conductive material as a conductive assistant. Such a conductive material is not particularly limited so long as it does not cause a chemical reaction inside the battery. The examples can include carbon black (e.g., thermal black, furnace black, channel black, ketjen black, acetylene black), carbon fibers, metal powders (e.g., powders of e.g., copper, nickel, aluminum, silver and etc.), metal fibers, polyphenylene derivatives (ones disclosed in Japanese Laid-Open Patent Publication No. S59-20971). One of these compounds can be used alone, or a combination of two or more kinds can be used. Among these examples, it is preferable to use carbon black, and it is more preferable to use ketjen black and acetylene black.

For example, the negative electrode can be prepared as follows. That is, a negative electrode active material and a binder, as well as a conductive assistant if necessary, are dispersed into a solvent such as N-methyl-2-pyrrolidone (NMP) or water to prepare a composition containing a negative electrode composition (here, the binder may be dissolved in the solvent), which is then applied onto one surface or both surface of a current collector. After drying, a calendar process is applied if necessary, so as to prepare a negative electrode. However, the method to prepare a negative electrode is not particularly limited thereto, and another method can be adopted to prepare it.

It is favorable that the thickness of the negative electrode composition layer is 10 to 100 μm per one surface of the current collector. Furthermore, the density of the negative electrode composition layer (which can be calculated from a thickness, and a mass of the negative electrode composition layer per a unit area stacked on the current collector) is preferably 1.0 g/cm³ or more for the purpose to attain a high capacity of a battery. It is more preferably 1.2 g/cm³ or more. Also, it is found that adverse effects such as a drop of osmosis of the nonaqueous electrolyte liquid can be induced when the negative electrode composition layer has an excessive density, and therefore, it is preferably 1.6 g/cm³ or less. Regarding the composition of the negative electrode composition layer, for example, it is preferable that the quantity of the negative electrode active material is 80 to 99 mass %, it is preferable that the quantity of the binder is 0.5 to 10 mass %, and it is preferable that the quantity conductive assistant, if used, is 1 to 10 mass %.

As a negative electrode current collector to collect electric current of the negative electrode and support the negative electrode composition layer, a foil made of copper or nickel can be used, for example. Also, a foil, punched metal, mesh or expanded metal made of copper or nickel can be used, which may have a through hole as penetrating from one surface of the negative electrode current collector to the other surface thereof. Regarding the thickness of the negative electrode current collector, it is preferable that the upper limit is 30 μm, and it is desirable that that the lower limit is 4 μm in view of securing a mechanical strength.

When he current collector used is a foil which does not have a through hole thereon, it can be possible to attain a larger contact area between the negative electrode composition layer and the negative electrode current collector. Therefore, even if the negative electrode composition layer is expanded or shrunk, its falling can be favorably prevented. In addition, a mechanical strength can be preferably secured.

Also, the negative electrode can be provided with a lead body, if necessary, for the purpose to connect it to other components inside the lithium secondary battery electrically. The lead body can be formed by a known method.

The positive electrode of the lithium ion secondary battery of the present invention has a structure, for example, in which a positive electrode composition layer including a positive electrode active material, a conductive assistant and a binder is formed on one surface or both surfaces of the positive electrode current collector.

As a positive electrode active material used in the positive electrode, a metal oxide (i.e., a lithium-containing transition metal oxide) constituted by Li and a metal M other than Li (e.g., Mg, Mn, Fe, Co, Ni, Cu, Zn, Al, Ti, Ge, Cr and etc.) can be used. For example, the examples of the lithium-containing transition metal oxide can include LiₓCoO₂, LiₓNiO₂, LiₓMnO₂, LiₓCo_{y}Ni_{1-y}O₂, LiₓCo_{y}M_{1-y}O₂, LiₓNi_{1-y}M_{y}O₂, LiₓMn_{y}Ni_{z}Co_{1-y-z}O₂. LiₓMu₂O₄ and LiₓMn_{2-y}M_{y}O₄. In each of the structural formulae above, M is at least one metallic element selected from the group consisting of Mg, Mn, Fe, Co, Ni, Cu, Zn, Al, Ti, Ge and Cr, and satisfy 0≦x≦1.1, 0<y<1.0, and 1.0<z<2.0.

The conductive assistant used in the positive electrode mentioned above should be one which is chemically stable inside the battery. The examples thereof can include: graphite such as natural graphite and artificial graphite; carbon black such as acetylene black, ketjen black (brand name), channel black, furnace black, lampblack and thermal black; conductive fiber such as carbon fiber and metal fiber; metallic powder such as aluminum flakes; fluorocarbon; zinc oxide; conductive whisker such as potassium titanate; conductive metal oxide such as titanium oxide; and organic conductive material such as polyphenylene derivatives. One of these compounds can be used alone, or a combination of two or more can be used. Among these compounds, it is preferable to use graphite being high in conductivity, or carbon black being superior in liquid-absorbing property. Also, the form of the conductive assistant is not necessarily in a primary particle, but can be of aggregates such as second aggregate, or of aggregates such as a chain structure. These aggregates are easy to handle and can improve the productivity.

As a binder of the positive electrode composition layer, PVDF, poly(vinylidene fluoride-chlorotrifluoroethylene) [P(VDF-CTFE)], polytetrafluoroethylene (PTFE) and SBR can be used.

For example, the positive electrode can be prepared as follows. That is, the positive electrode active material, the conductive assistant, the binder and etc. as described above are dispersed in a solvent such as NMP to prepare a composition containing a positive electrode composition in a paste or slurry state (here, the binder may be dissolved in the solvent), which is then applied on one surface or both surfaces of a current collector, and dried, and then, a calendar process is applied if necessary. However, the manufacturing method of the positive electrode is not particularly limited thereto, and another method can be adopted to prepare it.

It is favorable that the thickness of the positive electrode composition layer is, for example, 10 to 100 μm per one surface of the current collector. Regarding the composition of the positive electrode composition layer, for example, it is preferable that the quantity of the positive electrode active material is 65 to 95 mass %, it is preferable that the quantity of the binder is 1 to 15 mass %, and it is preferable that the quantity conductive assistant is 3 to 20 mass %.

The positive electrode current collector can be made of, for example, a foil of aluminum. Also, a foil, punched metal, mesh or expanded metal made of aluminum can be used, which may have a through hole as penetrating from one surface of the positive electrode current collector to the other surface thereof. Regarding the thickness of the positive electrode current collector, it is preferable that the upper limit is 30 μm, and it is desirable that the lower limit is 4 μm in view of securing a mechanical strength.

Also, the positive electrode can be provided with a lead body, if necessary, for the purpose to connect it to other components inside the lithium secondary battery electrically. The lead body can be formed through a known method.

A separator used in the lithium ion secondary battery of the present invention is preferably of a porous film made of, for example, polyolefin such as polyethylene, polypropylene and ethylene-propylene copolymer, or polyester such as polyethylene terephthalate and copolymerized polyester. In addition, it is preferable that the separator is provided with a property capable of closing its pores (i.e., shutdown function) when it reaches 100 to 140° C. For this reason, the separator preferably includes a thermoplastic resin having a melting point of 100 to 140° C. as its component. In this case, the melting point can be measured by means of a differential scanning calorimeter (DSC) in accordance with Japanese Industrial Standards (JIS) K 7121. The separator is preferably a single-layer porous film made of polyethylene as a main component, or a laminated porous film of two to five layers of polyethylene and polypropylene. When mixing polyethylene with another resin such as polypropylene having a higher melting point than polyethylene, or laminating the layers of these two resins, polyethylene is desirably included at 30 mass % or more, and it is more desirably included at 50 mass % or more, in the resins making up the porous film.

The examples used as the resin porous film can include a porous film made of any of thermoplastic resins mentioned above which have been used in conventionally-known lithium ion secondary batteries and the like. That is, the examples can include an ion-permeable porous film produced by means of a method of solvent extraction, dry drawing, wet drawing, or the like.

Regarding the average pore diameter of the separator, it is preferably 0.01 μm or more, or more preferably 0.05 μm or more, and it is preferably 1 μm or less, or more preferably 0.5 μm or less.

Regarding the characteristics as a separator, it desirably has a Gurley value of 10 to 500 sec. The Gurley value can be obtained in accordance with a method according to JIS P 8117 and expressed as a length of time (seconds) it takes for 100 ml air to pass through a membrane under a pressure of 0.879 g/mm². When the air permeability is excessively large, the ion permeability might be deteriorated. On the other hand, when the air permeability is excessively small, the strength of the separator might be declined. Furthermore, regarding the strength of the separator, it is desirable that the separator has a piercing strength of 50 g or more. The strength here is a piercing strength obtained by using a needle having a diameter of 1 mm. When the piercing strength is excessively small, in a case where lithium dendrite crystals are generated, the dendrite crystals might penetrate the separator throughout to cause a short circuit.

The separator used here can be a laminate type separator having a porous layer (I) mainly composed of a thermoplastic resin, and a porous layer (II) mainly composed of fillers having a heat resistant temperature of 150° C. or more. The separator above can be provided with properties of a shut-down function, a heat resistance (i.e., heat resistant shrinkage) and a high mechanical strength. Accordingly, the separator is expected to have a high mechanical strength to provide with a high resistance against the expansion or shrinkage of the negative electrode caused in the charge discharge cycles, while the separator is also expected to be restricted from being twisted and maintain the cohesiveness of the negative electrode, the separator and the positive electrode.

In the specification of the present application, the feature of “heat-resistant temperature of 150° C. or more” is referred to as a situation where a transformation such as softening does not start at least at a temperature of 150° C.

The porous layer (I) included in the laminated type separator is a layer provided to mainly secure the shutdown function, and thus, when the battery reaches the melting point of the main component resin of the porous layer (I), the resin contained in the porous layer (I) melts and closes the pores of the separator, thereby bringing about a shutdown to suppress the progress of the electrochemical reaction.

Regarding thermoplastic resin mainly constituting the porous layer (I), preferable examples thereof can include a resin having a melting point of 140° C. or less, such as PE. Here, the melting point can be measured by using a differential scanning calorimeter (DSC) in accordance with the standard defined in JISK7121. The examples of the porous layer (I) can include a microporous film usually used as a separator of lithium secondary batteries, and a sheet obtained by applying a dispersion containing PE particles on a substrate such as a non-woven fabric, which is followed by drying the substrate. In the total of the constituent components of the porous layer (I) (here, it is the total volume excluding the cavity potions; and the same standard applies to the volume content ratio of the components of the porous layer (I) and the porous layer (II)), it is preferable that the volume content ratio of the thermoplastic resin as a main component is 50 volume % or more, and more preferably 70 volume % or more. It is noted that in a case where the porous layer (I) is a PE microporous film, the volume content ratio of the thermoplastic resin is 100 volume %.

The porous layer (II) included in the separator has a function to prevent short circuit caused by direct contact between the positive electrode and the negative electrode, even if the internal temperature of the battery is raised. This function can be ensured by inorganic fillers having a heat resistance temperature of 150° C. or more. In other words, even when the battery temperature is raised at a high temperature and the porous layer (I) is shrunk, the porous layer (II) is not likely to be shrunk. Therefore, it can prevent the short circuit caused by direct contact between the positive and negative electrodes that could happen if a separator was caused thermal shrinkage. Also, the heat resistant porous layer (II) acts as a framework of the separator, and therefore it can be possible to restrict the thermal shrinkage of the porous layer (I), and thereby restricting the overall thermal shrinkage of the separator as well.

The fillers of the porous layer (II) can be either of organic particles or inorganic particles so long as they have a heat resistant temperature of 150° C. or more and are stable in the electrolyte liquid included in the battery, and furthermore are electrochemically stable and hard to cause a redox reaction within the range of the battery operation voltage. They are preferably of fine particles in view of dispersibility. In addition, it is preferable to use inorganic oxide particles, and it is more preferably to use alumina, silica or boehmite. Alumina, silica and boehmite have a high oxidation resistance, and are capable of adjust their particle size or shape into a desired numerical value. As a result, a cavity rate of the porous layer (II) can be precisely controlled. One kind of the fillers having a heat resistant temperature of 150° C. or more can be used alone, or a combination of two or more kinds can be used.

The fillers are mainly included in the porous layer (II). The volume content ratio can be preferably 70 volume % or more, and more preferably 80 volume % or more, and yet more preferably 90 volume % or more, in the total volume of the components of the heat resistance porous layer (II). In addition, since a binder should be usually included in the porous layer (II), the content of the fillers in the porous layer (II) can be preferably 99 volume % or less in the total volume of the components of the porous layer (II).

The examples of the binder of the porous layer (II) can include fluorine resin (e.g., PVDF), fluorine type rubber, SBR, CMC, hydroxyethyl cellulose (HEC), polyvinyl alcohol (PVA), polyvinyl butyral (PVB), polyvinylpyrrolidone (PVP), poly-N-vinyl acetamide, crosslinked acrylic resin, polyurethane and epoxy resin.

Regarding the thickness of the separator (i.e., a laminate type separator or any other separator), it is preferably 6 μm or more, and more preferably it is 10 μm or more, in view of securing the separation of the positive electrode from the negative electrode. On the other hand, when the thickness of the separator becomes excessively large, the energy density of the battery might be decreased. Therefore, the thickness can be preferably 50 μm or less, and it can be more preferably 30 μm or less.

In addition, the thickness of the porous film (I) can be preferably 5 to 30 μm (when there exist a plural layers of the porous film (I), the thickness here means a total thickness thereof). Furthermore, the thickness of the porous film (II) can be preferably 1 μm or more, and it is more preferably 2 μm or more, and it is yet more preferably 4 μm or more, but it is preferably 20 μm or less, and it is more preferably 10 μm or less, and it is yet more preferably 6 μm or less (here, when there exist a plural layers of the porous film (II), the thickness here means a total thickness thereof).

Regarding a nonaqueous electrolyte liquid used in the lithium ion secondary battery of the present invention, it can be a nonaqueous electrolyte solution which has dissolved a lithium salt in an organic solvent.

The organic solvent used as the non-aqueous electrolytic solution is not particularly limited to so long as it dissolves the lithium salt and does not cause a side reaction such as decomposition within the voltage range operating the battery. Examples of the organic solvent can include: cyclic carbonates such as ethylene carbonate, propylene carbonate, and butylene carbonate; chain carbonates such as dimethyl carbonate, diethyl carbonate, and methyl ethyl carbonate; chain esters such as methyl propionate; cyclic esters such as γ-butyrolactone; chain ethers such as dimethoxyethane, diethyl ether, 1,3-dioxolane, diglyme, triglyme, and tetraglyme; cyclic ethers such as dioxane, tetrahydrofuran, and 2-methyltetrahydrofuran; nitriles such as acetonitrile, propionitrile and methoxypropionitrile; and sulfurous esters such as ethylene glycol sulfite. The organic solvent that can be used here may be a mixture of two or more of these materials. In order to attain a better battery property, it is desirable to employ a combination of the materials that can be able to achieve a high conductivity. The examples in this purpose can include a mixture solvent of ethylene carbonate and a chain carbonate.

The lithium salt used in the non-aqueous electrolytic solution is not particularly limited to so long as it can dissociate in a solvent to produce lithium ions and is not likely to cause a side reaction such as decomposition within the voltage range to operate the battery. Examples of the lithium salt can include inorganic lithium salts such as LiClO₄, LiPF₆, LiBF₄, LiAsF₆, and LiSbF₆, and organic lithium salts such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦7), and LiN(RfOSO₂)₂ (where Rf represents a fluoroalkyl group).

The concentration of the lithium salt in the non-aqueous electrolytic solution can be preferably 0.5 to 1.5 mol/L, and more preferably 0.9 to 1.25 mol/L.

In addition, the nonaqueous electrolyte liquid can further contain an additive in view of making further improvement in the charge discharge cycle characteristics or for the purpose to improve the safety features such as high temperature storage property and overcharge prevention property. The examples of the additive in the purposes can include vinylene carbonate, vinylethylene carbonate, anhydrous acid, sulfonate, dinitrile, 1,3-propanesultone, diphenyl disulfide, cyclohexylbenzene, biphenyl, fluorobenzene, t-butylbenzene, phosphonoacetate compounds, and 1,3-dioxane (or derivatives thereof).

Furthermore, the nonaqueous electrolyte liquid can contain a known gelatification agent such as a polymer in order to be provided as a gel state (i.e., gelled electrolyte).

Conventional lithium ion secondary batteries could include: a stacked body (i.e., stacked electrode body) including a negative electrode and a positive electrode with an intervention of a separator therebetween; or a winding body (i.e., winding electrode body) by further winding the stacked body above into an eddy form. Comparing a stacked electrode body with a winding electrode body, the former can be easier to keep the distance between the positive electrode and the negative electrode even if the volume of the negative electrode is changed upon charge and discharge of the battery, and therefore, the battery properties can be well maintained. For these reasons, the lithium ion secondary battery of the present invention can use the stacked electrode body.

The lithium ion secondary battery of the present invention has the third electrode to dope Li ions into the negative electrode (i.e., the negative electrode composition layer). The third electrode can be arranged in such a manner that at least a part of the third electrode is opposed to the end surface of the stacked electrode body and that it is electrically connected to the negative electrode. Also, the third electrode used in the assembling stage of the battery can be provided with a Li supply source at a position opposed to the end surface of the stacked electrode body in order to dope Li ions.

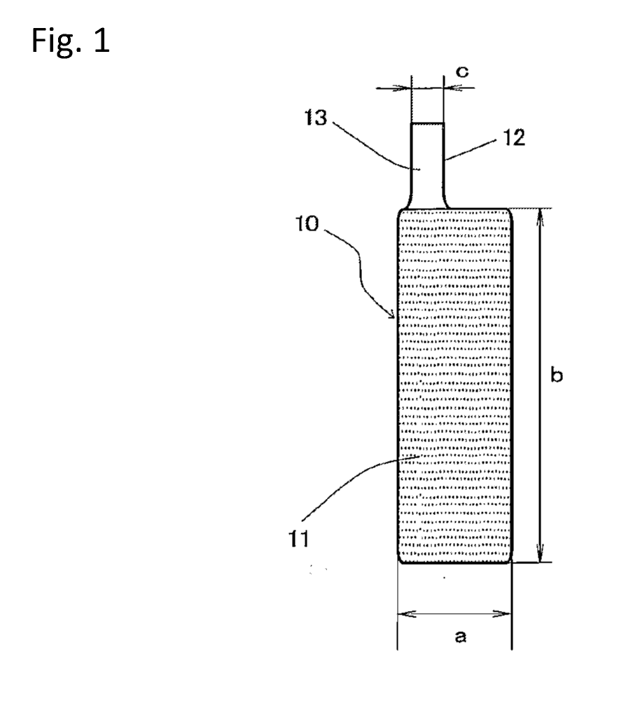

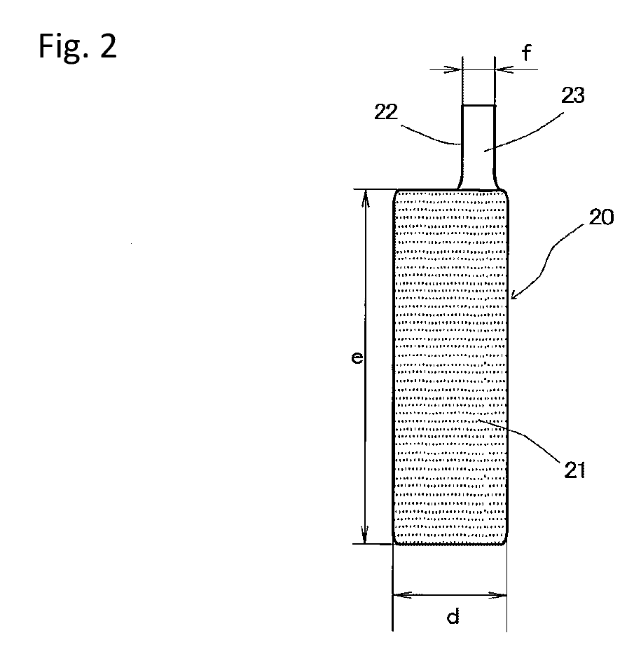

Next, the stacked electrode body is explained with reference to the drawings. FIG. 1 is a plan view schematically showing an example of the positive electrode of the lithium ion secondary battery of the present invention, and FIG. 2 is a plan view schematically showing an example of the negative electrode of the lithium ion secondary battery of the present invention. In FIG. 1, the positive electrode 10 has positive electrode composition layers 11 on both surfaces of the positive electrode current collector 12 (e.g., a metal foil made of aluminum) which has a positive electrode tab part 13. Also in FIG. 2, the negative electrode 20 has negative electrode composition layers 21 on both surfaces of the negative electrode current collector 22 (e.g., a copper metal foil) which has a negative electrode tab part 23.

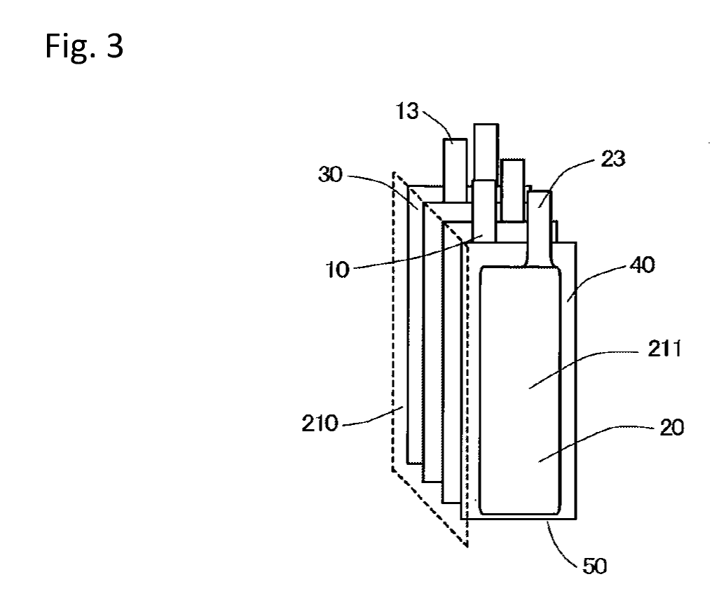

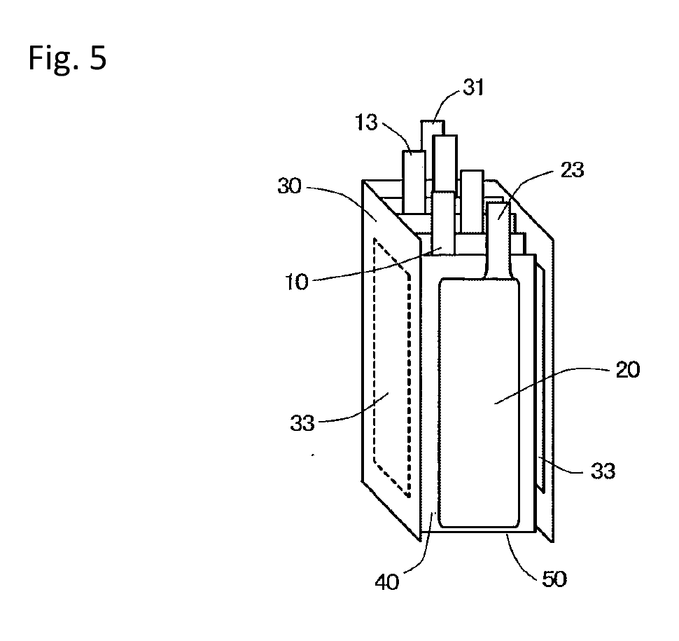

FIG. 3 is a perspective view schematically showing an example of the stacked electrode body of the lithium ion secondary battery of the present invention. The stacked electrode body 50 is formed as follows. Thai is, a negative electrode 20 shown in FIG. 2, a separator 40 and a positive electrode 10 shown in FIG. 1, a separator 40, and a negative electrode 20 are stacked in this order, and the stacking might be further repeated. In other words, the positive electrode 10 and negative electrode 20 are stacked with an intervention of the separator 40. Here, the end surface of the stacked electrode body 50 refers to the surface parallel to the stacking direction of the positive electrode 10, the negative electrode 20 and the separator 40 (the surface is, for example, a hypothetical surface 210 shown by the dotted line in FIG. 3). Also, the surface perpendicular to the stacking direction of the stacked electrode body is referred to as a plain surface (i.e., the surface 211 shown in FIG. 3) of the stacked electrode body. In the stacked electrode body 50 shown in FIG. 3, one sheet of the separator 40 is each provided between the positive electrode 10 and the negative electrode 20. There can be alternative embodiment in which a strip shape of the separator is folded in a shape of alphabetical character Z, inside which the positive electrode and the negative electrode is inserted. Also, the number of the sheets of the electrodes of the stacked electrode body is not particularly limited to a combination of three sheets of the negative electrodes and two sheets of the positive electrodes as shown in FIG. 3. Furthermore, plural positive electrode tab parts 13 and plural negative electrode tab parts 23 can be each connected to the positive electrode external terminal and the negative electrode external terminal, but such a configuration is omitted to show in FIG. 3 (also in FIG. 5 discussed later).

In FIG. 3, one end surface 210 and one plain surface 211 of the stacked electrode body 50 are illustrated. However, the invention is not particularly limited thereto. For example, there can be provided with another end surface 210 of the stacked electrode body 50 at the opposite surface of the hypothetical surface shown by the dotted line in FIG. 3, and the same is true for the plain surface 211 of the stacked electrode body 50. The end surface of the stacked electrode body is a plain surface as shown in FIG. 3, but it can be a curved surface depending on the shape of the electrode. The plain surface of the stacked electrode body can correspond to one surface of any of the positive electrode, negative electrode and separator.

Also in FIG. 3, two electrodes at the outermost layers of the stacked electrode body 50 are negative electrodes 20. However, alternative configuration can adopt one outermost layer being a positive electrode, or both outermost layers being positive electrodes.

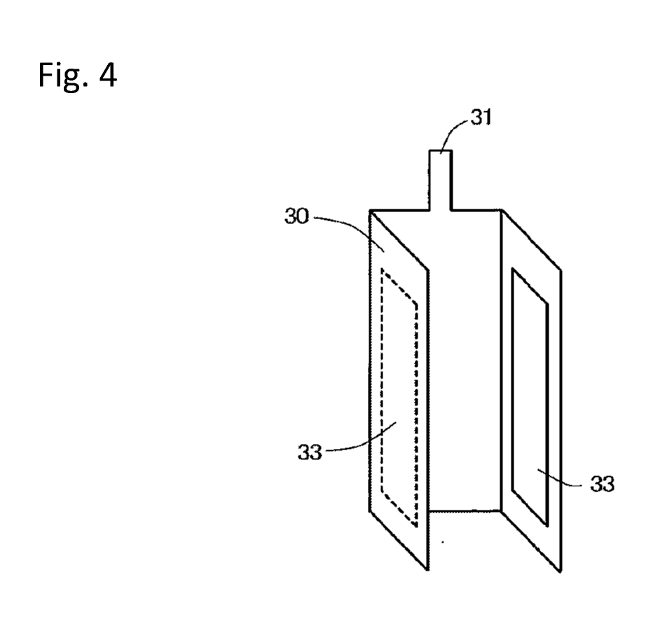

FIG. 4 schematically shows a perspective view of an example of the third electrode. Third electrode 30 has a third electrode current collector 32 and two Li supply sources 33, 33. Also, the third electrode current collector 32 is bent in an alphabet character C in such a manner that each of the two Li supply sources 33, 33 is located inside. In addition, the Li supply source 33 located at the left side of the drawing is shown by a dotted line. This illustrates a Li supply source 33 located on the back side of the third electrode current collector 32. In addition, the third electrode current collector 32 shown in FIG. 4 has a third electrode tab part 31.

FIG. 5 is a perspective view showing a condition when the stacked electrode body 50 of FIG. 3 in combination with the third electrode 30 of FIG. 4. Third electrode 30 can be arranged at the outside of the stacked electrode body 50 in such a manner that the two Li supply sources 33, 33 are respectively opposed to each of the two end surfaces of the stacked electrode body 50.

In FIG. 4 and FIG. 5, the Li supply sources 33, 33 are arranged in both the end surfaces of the third electrode current collector 32. However, alternative configuration can adopt such that only one can be arranged at one side of the end surface and one Li supply source is arranged at a portion to be opposed to one end surface of the stacked electrode body 50 at its upper part (i.e., the upper part of the drawing) or its lower part (i.e., the lower part of the drawing).

When using the material S as a negative electrode active material in accordance with the present invention, since the material S has relatively high irreversible capacity, it is desirable to introduce Li ions into the negative electrode in advance. In an electrochemical element having a stacked electrode body, the composition layers for the positive and negative electrodes were conventionally provided on a current collector made of a metal foil with a through hole, in such a manner that the surfaces of the composition layers were opposed to the Li (i.e., the Li source being opposed to the plain surfaces of the stacked electrode body in the meaning of the present invention), and therefore, Li ions could pass through the composition layer and the metal foil having the through hole, thereby introducing the Li ions into all the negative electrode composition layers of the stacked electrode body. In this case, the Li ions necessarily would be spread into all the negative electrodes in the battery through a negative electrode that is nearest to the Li source. However, the material S can accept a large amount of Li ions, but it necessarily shows a significant expansion upon accepting the Li ions. Therefore, in the conventional arrangement above, the negative electrode composition layer of the negative electrode which needed to accept the largest amounts of the Li ions (usually it is the negative electrode composition layer closest to the Li source) would receive the most amounts of Li ions, and therefore, this particular negative electrode composition layer thereby remarkably expanding locally. As a result, it might fall off by losing an adhesion state with the negative electrode current collector especially when given damages.

Therefore, the inventors of the present invention have found a new means to arrange the Li supply source at the end surface of the stacked electrode body to introduce Li ions into the negative electrode composition layer. When adopting the means above, even when employing a negative electrode active material showing a remarkable expansion and shrinkage upon charge and discharge, Li ions can be prevented from being excessively introduced into one negative electrode locally. As a result, the negative electrode composition layer can be prevented from falling off from the negative electrode current collector. In addition, the distance between each negative electrode and the Li source can be maintained constant, thereby restricting a negative electrode that can be extremely given damages due to the expansion. As a result, it can be possible to control the deterioration of the charge discharge cycle characteristic of the battery.

Furthermore, by adopting a metal foil which does not have a through hole as current collectors of the positive electrode and the negative electrode, an improvement of the strength can be expected compared with the case where a current collector with a through hole is used. With respect to the negative electrode current collector, the adhesion area with the composition layer can be increased to contribute to the restraint of the falling off the negative electrode composition layer.

The third electrode can be manufactured as follow. For example, there is provided a current collector made by e.g., a metal foil of copper or nickel (it can be one with a through hole as penetrating from one surface thereof to the other surface thereof), punched metal, mesh or expanded metal. An appropriate quantity of a Li foil (That is, a Li foil to become the Li supply source. This can include a metal Li foil and a Li alloy foil. The same notion is applied to hereinafter.) is pressed and adhered onto the third electrode current collector. Alternatively, it is of course possible that after a Li foil is pressed and adhered to the third electrode current collector, the third electrode current collector can be cut out to make a predetermined quantity of Li, thereby obtaining a third electrode.

With respect to the third electrode having the Li foil pressed and adhered to the third electrode current collector, for example, the tab part of the third electrode current collector is welded to the tab part of the negative electrode of the stacked electrode body, thereby making an electrical connection with the negative electrode. So long as the third electrode is electrically connected to the negative electrode of the stacked electrode body, there is no particular limitation to the technique or the embodiment. Other method than welding can be adopted to accomplish the electrical connection.

When a lithium ion secondary battery has completed the dope of Li ions into the negative electrode, the third electrode can be still left, but a part of the Li supply source provided on the third electrode can be left, or the whole of the Li supply source can disappear.

As the exterior body of the lithium ion secondary battery of the present invention, it is preferable to use a metal laminate film exterior body. The metal laminate film exterior body can be transformed more easily than, e.g., a metal can. Therefore, even if the negative electrode is expanded during the battery charge, it can prevent the negative electrode composition layer and the negative electrode current collector from being broken.

Regarding the metal laminate film constituting the metal laminate film exterior body, the example can include a metal laminate film made of a three-laminate structure including an exterior resin layer, a metal layer and an interior resin layer in this order.

Regarding the metal layer of the metal laminate film, the examples can include an aluminum film and a stainless steel film. Regarding the interior resin layer, the examples can include a film made of a thermal fusion bonding resin (e.g., a modified polyolefin ionomer showing a thermal fusion bonding property at a temperature at or around 110 to 165° C.). Regarding the exterior resin layer of the metal laminate film, the examples can include nylon film (e.g., 66 nylon film), polyester film (e.g., polyethylene terephthalate film) and so on.

Regarding the metal laminate film, the metal layer preferably has a thickness of 10 to 150 μm, the interior resin layer preferably has a thickness of 20 to 100 μm, and the exterior resin layer preferably has a thickness of 20 to 100 μm.

There is no particular limitation to the shape of the exterior body. The examples thereof can include a polygon shape such as triangle, quadrangle, pentagon, hexagon, heptagon, octagon and so on in a plain view. Generally, the shape is quadrangle (e.g., a rectangle or a square) in a plain view. In addition, there is no particular limitation to the size of the exterior body, and various sizes such as so-called a light form or large form can be used.

The metal laminate film exterior body can be constituted by, for example, folding a single sheet of a metal laminate film into two layers, or stacking two sheets of metal laminate films.

In addition, in a case where the exterior body in its plain view is a polygon, its side to make a positive electrode external terminal is the same as or different from the side to make a negative electrode external terminal.

It is preferable that a width of the thermal fusion bonding part in the exterior body is 5 to 20 mm.

The lithium ion secondary battery of the present invention can be used in a condition of an upper limit voltage of about 4.2V in the same manner as conventional lithium ion secondary batteries. However, it is possible to use it while setting up its upper limit voltage in charge at a voltage more than that, i.e., 4.4V or more. By doing this, a high capacity can be accomplished and even when repeatedly using it for a long term, superior characteristics can be maintained stably. In addition, it is preferable that the upper limit voltage of the charge of the lithium ion secondary battery can be 4.7V or less.

The lithium ion secondary battery of the present invention can be used as the same applications as those of lithium ion secondary batteries conventionally known.

### EXAMPLES

Hereinafter, the present invention is described in more details based on the examples. However, it is noted that the following examples should not be used to narrowly construe the scope of the present invention. Table 1 shows various physical properties of the negative electrode active materials (i.e., SiO, a composite having coated the surface of SiO with carbon material, and graphite) used in the Examples.

### Example 1

<Preparation of Positive Electrode>

96.5 parts by mass of a positive electrode active material LiCoO₂, 20 parts by mass of an NMP solution containing P(VDF-CTFE) as a binder at a concentration of 10 mass %, and 1.5 parts by mass of acetylene black as a conductive assistant were kneaded with a twin-screw extruder, into which NMP was further added to adjust the viscosity so as to prepare a positive electrode composition containing paste. The paste above was coated on both surfaces of an aluminum foil having a thickness of 15 μm, and then dried at 120° C. for 12 hours in vacuum to obtain a positive electrode composition layer having formed on both surfaces of the aluminum foil. It was then subject to a press work, and cut into a predetermined size to obtain a positive electrode in a belt shape. Here, when the aluminum foil was coated with the positive electrode composition containing paste, the aluminum foil was partly exposed in such a manner that a portion on the front surface where it was coated with the paste should have been correspondingly coated on the back surface. The thickness of the positive electrode composition layer of the positive electrode (here, when the positive electrode composition layer was formed on both surfaces of the aluminum foil, the thickness was with respect to one surface) was 55 μm.

The positive electrode in a belt shape having formed the positive electrode composition layer on both surfaces of the aluminum foil was punched with a Thompson blade in such a manner that the exposed part of the aluminum foil (i.e., the positive electrode current collector) was partly projected to become a tab part, and that the coated part of the positive electrode composition layer was shaped into nearly a quadrangle in which the four corners were rounded. Thereby obtained was a positive electrode for batteries having a positive electrode composition layer formed on both surfaces of the positive electrode current collector, as shown in FIG. 1. (Here, the sizes of the positive electrode shown in FIG. 1 does not necessarily agree with the actual size thereof for the purpose of easily understanding the structure of the positive electrode). The positive electrode 10 has a shape serving as a tab part 13 formed by being punched in such a manner that a part of the exposed part of the positive electrode current collector 12 was projected. The shape of the application part of the positive electrode composition layer 11 has nearly a quadrangle having the four corners rounded. Each length of a, b and c in the drawing was 8 mm, 37 mm and 2 mm, respectively.

<Preparation of Negative Electrode>

10 mass % of graphite A-1 (the surface of this graphite was not coated with an amorphous carbon); 10 mass % of graphite B-1 (this graphite is composed of graphite mother particles whose surfaces were coated with an amorphous carbon originated from pitch as a carbon source); and 80 mass % of a composite Si-1 in which the surfaces of SiO were coated with a carbon material (the materials S had an average particle size of 8 μm and a specific surface area of 7.9 m²/g, in which the quantity of the carbon materials in the composite was 20 mass %) were mixed with a V-type blender for 12 hours, thereby obtaining a negative electrode active material.

100 parts by mass of a polyacrylic acid were put into 500 parts by mass of ion exchanged water to be stirred and mixed, into which 70 parts by mass of NaOH were added and stirred to be dissolved until its pH value reached 7. Then, additional ion exchanged water was added to adjust its concentration to obtain a 5 mass % aqueous solution of a sodium salt of the polyacrylic acid. Into the aqueous solution above, the negative electrode active material as obtained above, an 1 mass % aqueous solution of CMC, and carbon black were added which were stirred for mixing to obtain a negative electrode composition containing paste. Here, the paste above had a composition ratio (i.e., a mass ratio) of the negative electrode active material, the carbon black, the sodium salt of the polyacrylic acid and CMC was 94:1.5:3:1.5.

The negative electrode composition containing paste above was applied on one surface or both surfaces of a copper foil having a thickness of 8 μm, and dried to form a negative electrode composition layer formed on the surface of the copper foil. After a press work process was applied to adjust the density of the negative electrode composition layer into 1.4 g/cm³. Then, it was cut with a predetermined size. As a result, there were obtained a negative electrode having a belt shape having formed the negative electrode composition layer on one surface of the negative electrode current collector, or a negative electrode having a belt shape having formed the negative electrode composition layer on both surfaces of the negative electrode current collector. Here, when the copper foil was coated with the negative electrode composition containing paste, the copper foil was partly exposed. When the negative electrode composition layer was formed on both surfaces of the negative electrode current collector, a portion on the front surface where it was coated with the paste should have been correspondingly coated on the back surface. The thickness of the negative electrode composition layer of the negative electrode obtained (that is, its thickness formed on one surface of the copper foil as a negative electrode current collector) was 65 μm.

The negative electrode in the belt shape was punched with a Thompson blade in such a manner that the exposed part of the copper foil (i.e., the negative electrode current collector) was partly projected to become a tab part, and that the coated part of the negative electrode composition layer was shaped into nearly a quadrangle which four corners were rounded. Thereby obtained was a negative electrode for batteries having a positive electrode composition layer formed on one surface or both surfaces of the negative electrode current collector, as shown in FIG. 2. (For easy understanding the structure of the negative electrode, the sizes of the negative electrode shown in FIG. 2 does not necessarily agree with the actual size thereof). The negative electrode 20 had a shape serving as a tab part 23 formed by being punched in such a way that a part of the exposed part of the negative electrode current collector 22 was projected. The shape of the formation part of the negative electrode composition layer 21 had nearly a quadrangle having the four corners curved. Each length of d, e and f in the drawing was 9 mm, 38 mm and 2 mm, respectively.

<Preparation of Third Electrode>

A third electrode 30 having a shape as shown in FIG. 4 was prepared as follow. A copper foil having a through hole penetrating from one surface thereof to the other surface thereof (its thickness was 10 μm, the diameter of the through hole was 0.1 mm, and the pore rate was 47%) was cut into a size of 45×25 mm, thereby obtaining a third electrode current collector 32 having a third electrode tab part 31 with a size of 2×2 mm. Furthermore, a Li foil 33 having a thickness of 200 μm and a mass of 18 mg was pressed and adhered to the portion close to both ends of the third electrode current collector 32, which was then folded into an alphabet character C such that the Li foils 33, 33 were located inside, and thereby obtaining the third electrode 30.

<Assembling of Battery>

A stacked body was formed by using two sheets of the negative electrodes for batteries, each having formed the negative electrode composition layer on one surface of the negative electrode current collector; 16 sheets of the negative electrodes for batteries, each having formed the negative electrode composition layer on both surfaces of the negative electrode current collector; 17 sheets of the positive electrodes for batteries, each having formed the positive electrode composition layer on both surfaces of the positive electrode current collector; and a separator made by polyethylene (thickness was 12 μm). In the stacked body above, the negative electrodes for batteries having formed the negative electrode composition layer on one surface of the negative electrode current collector were arranged at the outermost positions of the stacked electrode body, inside of which the positive electrodes for batteries having formed the positive electrode composition layer on both surfaces of the positive electrode current collector and the negative electrodes for batteries having formed the negative electrode composition layer on both surfaces of the negative electrode current collector were alternatively arranged. In addition, one sheet of the separator was intervened between each of the positive electrodes for batteries and each of the negative electrodes for batteries. Also, when stacking the positive electrodes for batteries and the negative electrodes for batteries, all the tab parts of the positive electrodes for batteries were arranged to project into the same one side direction, while all the tab parts of the negative electrodes for batteries were arranged to project to the same another side direction, which was different direction of the projecting of the tab parts of the positive electrodes for batteries.

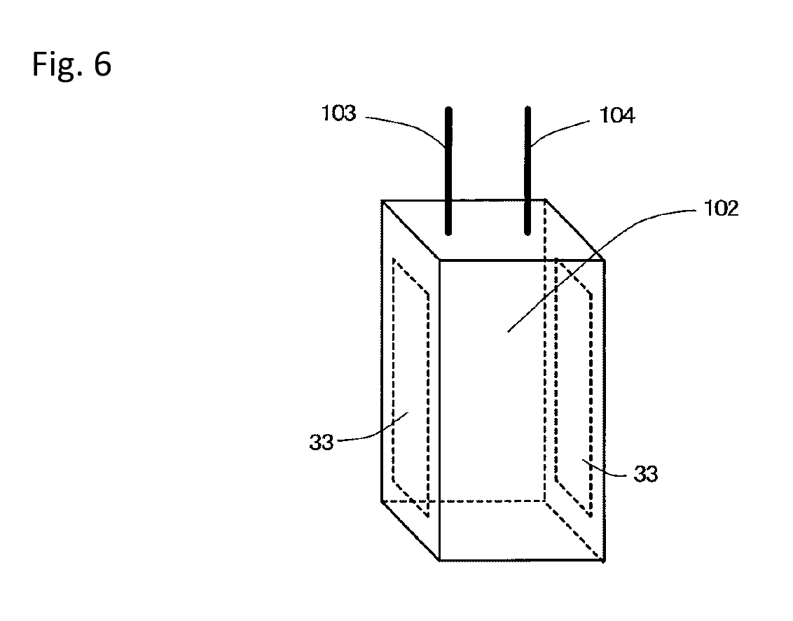

Next, the third electrode was stacked on the stacked body. Regarding the position relation of the stacked body and the third electrode, when the third electrode was stacked on the stacked body, there was maintained a position relation of the stacked electrode body 50 and the third electrode 30 as shown in FIG. 5. Furthermore, regarding the stacked body, the tab parts of the positive electrodes for batteries were welded to make a unified body which was then welded to the positive electrode external terminal of the battery. Also, with respect to the stacked body, the tab parts of the negative electrodes for batteries and the third electrode were welded together to make a unified body which was then welded to the negative electrode external terminal for battery, thereby obtaining an electrode body. FIG. 6 schematically shows a perspective view showing the electrode body obtained. In FIG. 6, the drawing of the stacked body does not appear the details of stacking of the positive electrode, the negative electrode and the separator, but the following configurations are included here. The electrode body 102 includes the third electrode stacked on the stacked body in such a manner that the end surfaces of the stacked body are opposed to the Li foils 33, 33. In addition, all the positive electrode tab parts of the positive electrode in the stacked body are integrally welded to form a unified body, which is welded to the positive electrode external terminal 103. Also, all the negative electrode tab parts of the negative electrode in the stacked body and the tab part of the third electrode in the stacked body are integrally welded to form a unified body, which is welded to the negative electrode external terminal 104. Then, the positive electrode external terminal 103 and the negative electrode external terminal 104 are drawn from the main body of the electrode body 102.

Then, there was provided an aluminum laminate film having a thickness of 0.15 mm, a width of 34 mm and a height of 50 mm with a cavity to house the electrode body. Into the cavity, the electrode body was inserted, and then, another aluminum laminate film having the same size was arranged on the top. Then, the three sides of the aluminum laminate films were welded together.

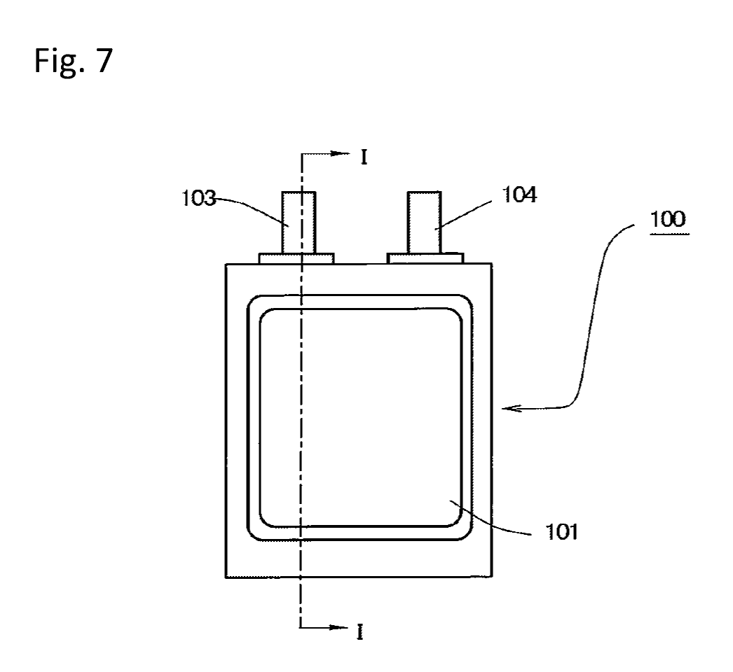

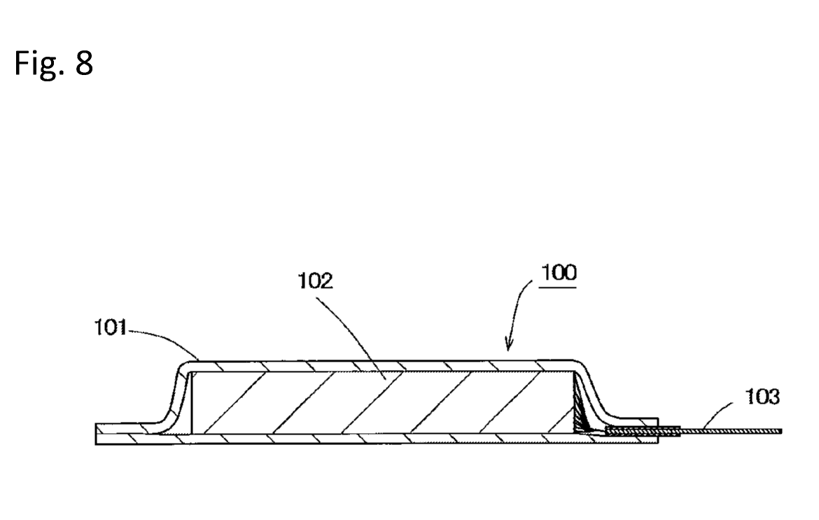

Then, from the remaining one side of the aluminum laminate films, a nonaqueous electrolyte liquid (i.e., a solution made by providing a mixture solvent of ethylene carbonate and diethyl carbonate at a volume ratio of 3:7, into which LiPF₆ was dissolved at a concentration of 1 mol/L, followed by adding 3 mass % of vinylene carbonate) was injected. Then, the remaining one side of the aluminum laminated films was sealed by means of a vacuum heat process. Thereby obtained was a lithium ion secondary battery having an appearance shown in FIG. 7, and its cross-sectional structure is shown in FIG. 8.

Here, FIG. 7 and FIG. 8 are explained. FIG. 7 is a plan view schematically showing a lithium ion secondary battery, and FIG. 8 is its cross section view at line I-I of FIG. 7. The lithium ion secondary battery 100 has a structure below. Inside the aluminum laminate film exterior body 101 composed of two sheets of aluminum laminate films, there are provided the laminated electrode body 102, and the nonaqueous electrolyte liquid (not shown). The aluminum laminate film exterior body 101 has a structure in which the outer periphery thereof is sealed by means of heat fusion of the aluminum laminate films at the top and the bottom thereof. It is noted that the illustration in FIG. 8 is simplified such that it does not expressly show each layer constituting the aluminum laminate film exterior body 101, and the positive electrode, the negative electrode, the separator and the third electrode constituting the electrode body.

The positive electrodes in the electrode body 102 are connected with each other by welding the tab parts to be unified. The unified body of the tab parts welded in this way is connected to the positive electrode external terminal 103 inside battery 100. In addition, while not illustrated in the drawing, the negative electrodes and the third electrode in the electrode body 102 are connected with each other by welding the tab parts to become unified, and the unified body of the tab parts welded in this way is connected to the negative electrode external terminal 104 inside battery 100. Then, the positive electrode external terminal 103 and the negative electrode external terminal 104 are drawn outside the aluminum laminate film exterior body 101 to be able to connect them to an external device.

The lithium ion secondary battery as prepared above was kept in a constant temperature bath at a temperature of 45° C. for 1 week.

### Examples 2 to 9

The negative electrode active materials shown in Table 1 were mixed at the mass ratio shown in Table 2. The Li foil was pressed and adhered to the third electrode at the mass (i.e., the quantity of Li) shown in Table 2. Except for the notes here, the same procedure as Example 1 was carried out to prepare a lithium ion secondary battery.

### Example 10

<Preparation of Separator>

3 parts by mass of a denatured polybutylacrylate as a resin binder, 97 parts by mass of boehmite powders (average particle diameter was 1 μm), and 100 parts by mass of water were mixed to prepare a slurry to form a porous layer (II). This slurry was coated on one surface of a fine porous membrane made of polyethylene for lithium ion batteries with a thickness of 12 μm [that is, a porous layer (I)], and dried. Thus, there was prepared a separator in which one surface of the porous layer (I) was provided with the porous layer (II) mainly constituted by boehmite. Here, the thickness of the porous layer (II) was 3 μm.

Except for using this separator, the same procedure as Example 5 was carried out to prepare a lithium ion secondary battery.

### Example 11

Except for using the same separator as prepared in Example 10, the same procedure as Example 1 was carried out to prepare a lithium ion secondary battery.

### Example 12

Except for using the same separator as prepared in Example 10, the same procedure as Example 2 was carried out to prepare a lithium ion secondary battery.

### Example 13

Except for using the same separator as prepared in Example 10, the same procedure as Example 4 was carried out to prepare a lithium ion secondary battery.

### Examples 14 and 15

Except for making the Li foil pressed and adhered to the third electrode at the mass shown in Table 2, the same procedure as Example 1 was carried out to prepare a lithium ion secondary battery.

### Comparative Example 1

<Preparation of Third Electrode>

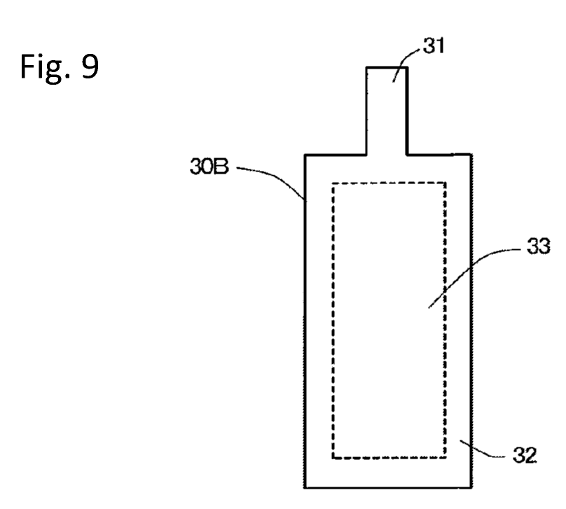

FIG. 9 is a plan view schematically showing the third electrode used in the battery of Comparative Example 1. A copper foil having a through hole penetrating from one surface thereof to the other surface thereof (its thickness was 10 μm, the diameter of the through hole was 0.1 mm, and the pore rate was 47%) was cut into a size of 45×25 mm, thereby obtaining a third electrode current collector 32 having a third electrode tab part 31 with a size of 2×2 mm. Furthermore, a Li foil 33 having a thickness of 200 μm and a mass of 36 mg was pressed and adhered to the portion at the center surface of the third electrode current collector 32, thereby obtaining a third electrode 30B.

Except for using this third electrode, the same procedure as Example 1 was carried out to prepare a lithium ion secondary battery.

### Comparative Example 2

Except for omitting a third electrode, the same procedure as Example 1 was carried out to prepare a lithium ion secondary battery.

Various properties as explained below were evaluated on the lithium ion secondary batteries of the Examples and the Comparative Examples thus prepared.

<Evaluation on Charge Discharge Cycle Characteristic>

The lithium ion secondary batteries of the Examples and the Comparative Examples were kept still in a constant temperature bath at 45° C. for 1 week. Then, the batteries were kept still in a constant temperature bath at 25° C. for 5 hours. Then, each battery was charged with a constant current at a current value of 0.5 C to reach 4.4V, followed by charging it at a constant voltage at 4.4V (a total charge time of the constant current charge and the constant voltage charge was 2.5 hours). Then, it was discharged with a constant current of 0.2 C to reach 2.0V, thereby determining an initial discharge capacity. Then, each battery was charged at a constant current at a current value of 1 C to reach a voltage of 4.4V and then charged at a constant voltage of 4.4V to reach a current value of 0.05 C, and then discharged at a current value of 1 C to reach a voltage of 2.0V. These sequential steps were assumed as one cycle. This cycle was repeated 300 times. Then, each battery was subject to a constant-current constant-voltage charge and a constant-current discharge at the same conditions as having measured the initial discharge capacity above, so as to obtain a discharge capacity. Then, the value of the discharge capacity was divided by the value of the initial discharge capacity. This result was expressed as a percentage, thereby obtaining a cycle capacity maintenance rate.

With respect to the lithium ion secondary batteries of the Examples and the Comparative Examples, the composition of the negative electrode active material as well as the quantity of Li (i.e., the mass per one sheet of the Li foil) provided on the third electrode are shown in Table 2, and the evaluation results as explained above are shown in Table 3.

TABLE 1

| | | Average | specific | | |
|---|---|---|---|---|---|
| | | particle | surface | | |
| | | diameter | area | D₀₀₂ | R value |
| | Form | (μm) | (m²/g) | (nm) | (—) |
| Si-1 | SiO carbon coating | 8 | 7.9 | — | 1.00 |
| Si-2 | SiO carbon coating | 5 | 5.8 | — | 0.91 |
| Si-3 | SiO | 0.5 | 9.5 | — | — |
| Graphite A-1 | Artificial graphite | 22 | 3.8 | 0.338 | 0.12 |
| Graphite B-1 | Amorphous carbon | 10 | 3.9 | 0.336 | 0.40 |
| | coated graphite | | | | |

TABLE 2

| | Composition of Negative Electrode active material | | | | | | |
|---|---|---|---|---|---|---|---|
| | | | | Graphite | Graphite | Quantity | |
| | Si-1 | Si-2 | Si-3 | A-1 | B-1 | of Li | |
| | (mass %) | (mass %) | (mass %) | (mass %) | (mass %) | (mg/a sheet) | Li/M |
| Example 1 | 80 | 0 | 0 | 10 | 10 | 18 | 0.91 |
| Example 2 | 90 | 0 | 0 | 10 | 0 | 20 | 0.91 |
| Example 3 | 90 | 0 | 0 | 0 | 10 | 20 | 0.91 |
| Example 4 | 100 | 0 | 0 | 0 | 0 | 23 | 0.91 |
| Example 5 | 50 | 0 | 0 | 25 | 25 | 11 | 0.91 |
| Example 6 | 0 | 50 | 0 | 25 | 25 | 11 | 0.91 |
| Example 7 | 0 | 0 | 50 | 25 | 25 | 11 | 0.91 |
| Example 8 | 20 | 0 | 0 | 40 | 40 | 5 | 0.91 |
| Example 9 | 5 | 0 | 0 | 47.5 | 47.5 | 1 | 0.91 |
| Example 10 | 50 | 0 | 0 | 25 | 25 | 11 | 0.91 |
| Example 11 | 80 | 0 | 0 | 10 | 10 | 18 | 0.91 |
| Example 12 | 90 | 0 | 0 | 10 | 0 | 20 | 0.91 |
| Example 13 | 100 | 0 | 0 | 0 | 0 | 23 | 0.91 |
| Example 14 | 80 | 0 | 0 | 10 | 10 | 15 | 0.8 |
| Example 15 | 80 | 0 | 0 | 10 | 10 | 23 | 1.05 |
| Comp. Ex. 1 | 80 | 0 | 0 | 10 | 10 | 18 | 0.72 |
| Comp. Ex. 2 | 80 | 0 | 0 | 10 | 10 | 0 | 0.71 |

TABLE 3

| | cycle capacity maintenance rate (%) |
|---|---|
| Example 1 | 73 |
| Example 2 | 71 |
| Example 3 | 71 |
| Example 4 | 70 |
| Example 5 | 75 |
| Example 6 | 75 |
| Example 7 | 75 |
| Example 8 | 86 |
| Example 9 | 90 |
| Example 10 | 80 |
| Example 11 | 75 |
| Example 12 | 72 |
| Example 13 | 71 |
| Example 14 | 70 |
| Example 15 | 70 |
| Comp. Ex. 1 | 20 |
| Comp. Ex. 2 | 21 |

There can be provided other embodiments than the description above without departing the gist of the present invention. The embodiment described above is an example only, and the present invention is not limited to the specific embodiment. The scope of the present invention should be construed primarily based on the claims, not to the description of the specification or the present application. Any changes within the terms of the claims and the equivalence thereof should be construed as falling within the scope of the claims.

### EXPLANATION OF THE REFERENCES IN THE DRAWINGS

10: Positive electrode;
11: Positive electrode composition layer;
12: Positive electrode current collector;
13: Tab part;
20: Negative electrode;
21: Negative electrode composition layer;
22: Negative electrode current collector;
23: Tab part:
30: Third electrode:
31: Third electrode tab part;
32: Third electrode current collector;
33: Li supply source (Li foil)
40: Separator;
50: Stacked electrode body;
100: Lithium ion secondary battery;
101: Metal laminate film exterior body;
102: Electrode body
103: Positive electrode external terminal: and
104: Negative electrode external terminal.

What is claimed is:

1: A lithium ion secondary battery, comprising:
a stacked electrode body comprising a positive electrode, a negative electrode, and a separator interposing between the positive electrode and the negative electrode; and
a third electrode used to dope Li ions into the negative electrode,
wherein the stacked electrode body has a plain surface and an end surface parallel to a stacked direction of the positive electrode, the negative electrode and the separator,
wherein the negative electrode comprises a negative electrode composition layer comprising a negative electrode active material at least on one surface of a negative electrode current collector,
wherein the negative electrode active material includes a material S including Si,
wherein assuming that 100 mass % is a total of the negative electrode active material included in the negative electrode composition layer, a content of the material S is higher than 5 mass %,
wherein the positive electrode comprising a positive electrode composition layer comprising a metal oxide of Li and a metal M other than Li as a positive electrode active material, the positive electrode composition layer being arranged on at least one surface of a positive electrode current collector,
wherein the third electrode is arranged in such a manner that at least a part of the third electrode is opposed to the end surface of the stacked electrode body,
wherein when the lithium ion secondary battery is discharged at a discharge current rate of 0.1 C to reach a voltage reaches 2.0V, a molar ratio (Li/M) of the Li and the metal M other than Li included in the positive electrode active material is 0.8 to 1.05.

2: The lithium ion secondary battery according to claim 1, wherein SiO, (0.5≦x≦1.5) is included as the material S.

3: The lithium ion secondary battery according to claim 1, wherein the separator comprises a porous membrane (I) mainly composed of a thermoplastic resin, and a porous layer (II) mainly composed of fillers having a heat resistant temperature of 150° C. or more.

4: A lithium ion secondary battery, comprising:
a stacked electrode body comprising a positive electrode, a negative electrode, and a separator interposing between the positive electrode and the negative electrode; and
third electrode used to dope Li ions into the negative electrode,
wherein the stacked electrode body has a plain surface and an end surface parallel to a stacked direction of the positive electrode, the negative electrode and the separator,
wherein the negative electrode comprises a negative electrode composition layer comprising a negative electrode active material at least on one surface of a negative electrode current collector,
wherein the negative electrode active material includes a material S including Si,
wherein assuming that 100 mass % is a total of the negative electrode active material included in the negative electrode composition layer, a content of the material S is higher than 5 mass %,
wherein the positive electrode comprising a positive electrode composition layer comprising a metal oxide of Li and a metal M other than Li as a positive electrode active material, the positive electrode composition layer being arranged on at least one surface of a positive electrode current collector,
wherein the third electrode comprises a Li supply source in a manner that the third electrode is arranged such that the Li supply source is opposed to the end surface of the stacked electrode body,
wherein the negative electrode is doped with Li ions supplied from the Li supply source by making an electrical connection to the third electrode.

5: The lithium ion secondary battery according to claim 4, wherein SiOₓ (0.5≦x≦1.5) is included as the material S.

6: The lithium ion secondary battery according to claim 4, wherein the separator comprises a porous membrane (I) mainly composed of a thermoplastic resin, and a porous layer (II) mainly composed of fillers having a heat resistant temperature of 150° C. or more.

7: A method for producing a lithium ion secondary battery, the method producing a lithium ion secondary battery comprising:
a stacked electrode body comprising a positive electrode, a negative electrode, and a separator interposing between the positive electrode and the negative electrode, the negative electrode comprising a negative electrode composition layer comprising a negative electrode active material at least on one surface of a negative electrode current collector, the negative electrode active material including a material S including Si; and
third electrode used to dope Li ions into the negative electrode,
wherein the stacked electrode body has a plain surface and an end surface parallel to a stacked direction of the positive electrode, the negative electrode and the separator:
the method comprising: providing the third electrode comprising a Li supply source in a manner that the third electrode is arranged such that the Li supply source is opposed to the end surface of the stacked electrode body, and
making an electrical connection to the third electrode such that the negative electrode is doped with Li ions supplied from the Li supply source.
